(19) United States
(12) Patent Application Publication
(10) Pub. No.: US 2010/0324851 A1
(43) Pub. Date: Dec. 23, 2010

(54) Method for Determining the Exhaust Gas Temperature of a Vehicle Engine

(76) Inventor: Ulrich SCHNEIDER, Kirchheim (DE)

Correspondence Address: WALTER A. HACKLER, 2372 S.E. BRISTOL, SUITE B, NEWPORT BEACH, CA, 92660-0755, US

(21) Appl. No.: 12/796,254

(22) Filed: Jun. 8, 2010

(30) Foreign Application Priority Data
Jun. 22, 2009 (DE) 10 2009 030 206.9

(51) Int. Cl. G01K 13/00; G01K 15/00; G06F 19/00

(52) U.S. Cl. 702/99

(57) ABSTRACT

The invention relates to a method for determining the exhaust gas temperature of a vehicle motor using a temperature probe comprising a temperature sensor and a protective tube, which surrounds the temperature sensor and projects into an exhaust gas flow. According to the invention, a corrected temperature value is calculated from a plurality of chronologically consecutive temperature measurement values, using a characteristic of the thermal inertia of the temperature probe. The invention further relates to a temperature probe comprising an evaluation unit, which during operation carries out such a method.

The invention relates to a method for determining the exhaust gas temperature of a vehicle motor using a temperature probe comprising a temperature sensor and a protective tube, which surrounds the temperature sensor and projects into an exhaust gas flow. Such a temperature probe and a method having the features mentioned in the preamble of claim 1 are known from DE 10 2006 034 248 B3.

The usage conditions for temperature probes in the exhaust tract of internal combustion engines are difficult. They are characterized by high temperatures of more than 600° C. up to around 1000° C., fast temperature changes, such as due to temperature increases by 800° C. within 5 seconds, vibrations, and corrosive media flowing around them.

In order to be able to withstand these stresses, the temperature sensors of temperature probes for measuring the exhaust gas temperature are enclosed in a protective tube and typically embedded in a filler material, such as a powder or a potting compound. However, these measures for protecting the sensor also increase the inertia of the temperature probe, thereby generally achieving better protection of the sensor and therefore an extended service life in exchange for higher inertia of the sensor.

It is an object of the invention to indicate a way as to how the contradicting requirements of the longest service life of a temperature probe possible and the fastest and most precise determination of the exhaust gas temperature possible can be better satisfied.

### SUMMARY OF THE INVENTION

In the method according to the invention, a corrected temperature value is calculated from a plurality of chronologically consecutive temperature measurement values, using a characteristic of the thermal inertia of the temperature probe. Advantageously, in this way a robust temperature probe, which is able to withstand the high stresses in the exhaust tract of a motor vehicle for a long time, can be used to determine the exhaust gas temperature more quickly and more precisely, despite a significant thermal inertia of the temperature probe.

In the case of a change of the exhaust gas temperature, a certain amount of time always passes until a temperature probe has assumed the temperature of the ambient exhaust gas flow and can supply temperature measurement values which agree with the exhaust gas temperature. During heating or cooling of the temperature probe to the exhaust gas temperature, the temperature measurement values therefore systematically differ from the actual exhaust gas temperature and approach the same with some time delay. The speed with which a temperature probe assumes the temperature of an exhaust gas flow is determined by the thermal inertia thereof, which depends on the thermal capacity of the temperature probe and the thermal conductivity of the components thereof surrounding the temperature sensor. By using a characteristic quantity that characterizes the thermal inertia of the temperature probe, a method according to the invention can be used to calculate a corrected temperature value from temperature measurement values of the sensor, with the corrected value better corresponding to the exhaust gas temperature.

A time constant, which characterizes the speed with which the temperature probe assumes a changed ambient temperature, can be used as the characteristic of the thermal inertia of the temperature sensor. Such a time constant can be determined for a particular temperature probe through suitable measurements, for example, in that the temperature probe having a defined initial temperature, such as 20° C., is introduced into a hot exhaust gas flow having a known temperature, such as 520° C. in such a case, the measurement values supplied by the temperature sensor over time exponentially approach the exhaust gas temperature. A characteristic of the thermal inertia that can be used, for example, is the time which passes until the difference between the temperature of the temperature probe and the exhaust gas temperature has decreased to a specified portion of the initial difference. For this purpose, it is advantageous to define the time constant as the time period which passes until the difference has dropped to 1/e of the initial difference. Here, e is Euler's number, which is approximately 2.718, so that the time constant used is advantageously the time at which the sensor has reproduced 63% of the jump following a sudden change in the exhaust gas temperature.

Strictly speaking, the time constant determined in this way also depends on the density and flow rate of the exhaust gas flow. For practical purposes, the differences in the exhaust gas volume flowing past a temperature probe per time unit, which result for different engine loads and engine speeds, are generally negligible. Advantageously, the characteristic quantity of the thermal inertia of the sensing probe used is therefore determined on an exhaust gas flow, which is obtained at a typical engine state, such as a mean speed and mean engine load.

The corrected temperature value is preferably calculated in that a corrective term, which is proportional to a deviation from a preceding temperature value and calculated using the characteristic quantity of thermal inertia, is added to a temperature measurement value, such as by multiplication with the characteristic quantity. The corrective term is preferably inversely proportional to the time period between the two temperature measurement values, the corrective term being proportional to the difference thereof.

### BRIEF DESCRIPTION OF THE DRAWINGS

Further details and advantages of the invention will be described on an exemplary embodiment with reference to the attached drawings. Shown are:

FIG. 1 the heating behavior of two different temperature probes during a sudden change of the temperature of a surrounding gas flow; and

FIG. 2 the curve of the temperature measurement values measured in the exhaust gas flow and the curve of the exhaust gas temperature, and the deviation of a corrected temperature value, calculated according to the invention, from the exhaust gas temperature for two different temperature probes.

### DETAILED DESCRIPTION

In order to determine the exhaust gas temperature of a vehicle engine, a series of temperature measurement values are generated using a temperature probe comprising a temperature sensor and a protective tube, which surrounds the temperature sensor and projects into the exhaust gas flow. A corrected temperature value is calculated from a plurality of chronologically consecutive temperature measurement values, using a characteristic quantity of the thermal inertia of the temperature probe.

A time constant, which characterizes the speed with which the temperature probe assumes a changed ambient temperature, is used as the characteristic of the thermal inertia of the temperature sensor. The time constant can be determined, for example, in that a temperature probe having a known initial temperature is introduced into an exhaust gas flow having a constant temperature, so that the temperature of the temperature probe, and hence the measurement values it supplies, slowly approach the changed ambient temperature.

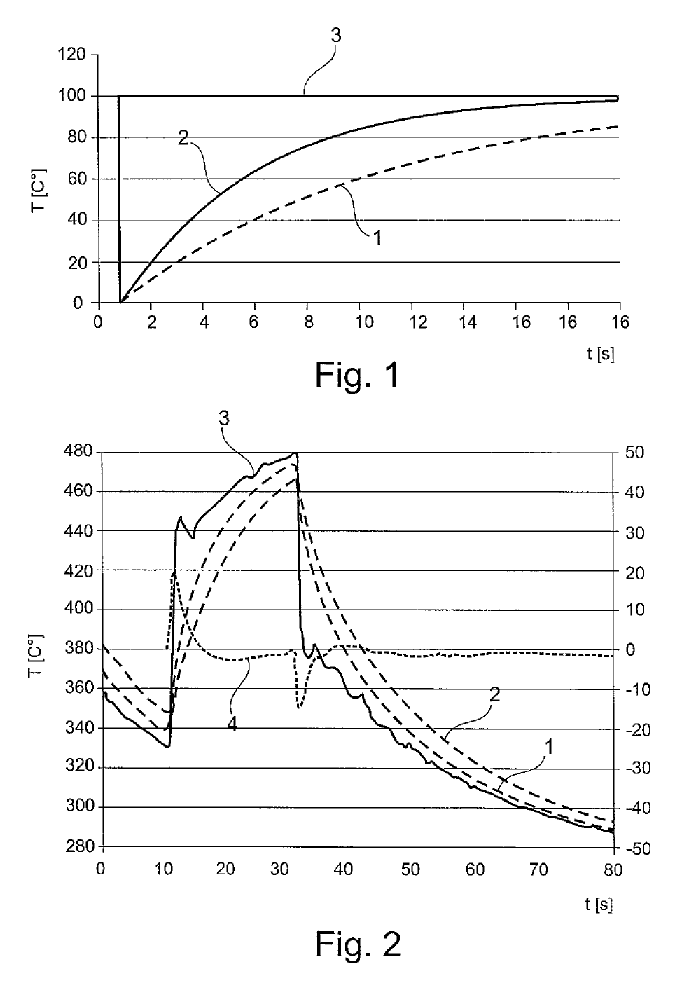

FIG. 1 shows, by way of example, the temperature curve for two different temperature probes during a sudden change of the ambient temperature. In FIG. 1, the ordinate indicates the temperature T in ° C. and the abscissa indicates the time t in seconds. Curve 1 is the temperature curve of a first temperature probe, and curve 2 is the temperature curve of a second temperature probe having a lower thermal inertia. The ambient temperature is illustrated by the step function 3 in FIG. 1. It is clearly apparent that the ambient temperature suddenly increases from 0° C. to 100° C. at the time t=1 s.

At the time t=1 second, the difference between the temperature of the two temperature probes and the ambient temperature is therefore 100° C. After approximately 10 seconds, the temperature difference has dropped to 37%, that is 1/e of the initial value, for the first temperature probe. After 10 seconds, the first temperature sensor has thus reproduced 63% of the sudden change of the exhaust gas temperature. The time constant τ of the first temperature probe is therefore 10 seconds.

The second temperature probe has a lower thermal inertia and therefore has already reproduced 63% of the sudden change of the ambient temperature after approximately 5 seconds. The difference between the temperature of the second temperature probe and the ambient temperature has therefore dropped to the (1/e)th portion of the original temperature difference of 100 K after only 5 seconds. The time constant τ of the second temperature probe is therefore 5 seconds.

During operation, the temperature probes generate a series of temperature measurement values T₁, T₂, T₃ . . . Tₙ₋₁, Tₙ, wherein the individual temperature measurement values are each measured for the times t₁, t₂, t₃ . . . tₙ₋₁, tₙ. The index n denotes an arbitrary integer because the temperature measurement values are generated continuously. Using a characteristic quantity of the thermal inertia of the temperature probe, such as the time constant τ, a corrected temperature value T_{cor} can then be calculated, which is closer to the exhaust gas temperature. The corrected temperature value can then be calculated, for example, for the time tₙ according to the following equation:

T_{cor}=Tₙ+ΔT·τ/Δt

Here, Tₙ is the temperature measurement value measured at the time tₙ, ΔT is the difference between the consecutive temperature measurement values Tₙ and Tₙ₋₁, that is ΔT=Tₙ−Tₙ₋₁, and Δt is the difference between the consecutive times tₙ and tₙ₋₁, that is Δt=tₙ−tₙ₋₁.

The equation above is used to calculate a corrected temperature value in that a corrective term, that is ΔT·τ/Δt, is added to a temperature measurement value. This corrective term is proportional to a deviation from a preceding temperature value and proportional to the characteristic quantity of the thermal inertia of the temperature probe. The corrective term is additionally inversely proportional to the time period Δt between the two temperature measurement values, the corrective term being proportional to the difference Δt thereof.

The measurement signals supplied by a temperature probe inserted in the exhaust tract of a vehicle are frequently noisy and impaired by interfering signals. It is therefore preferred to determine the temperature measurement values used for calculating the corrected temperature value by filtering the raw data supplied by the temperature sensor, such as an electric measuring resistor or a thermocouple. During the filtration of raw data, for example, a temperature measurement value can be formed by combining a plurality of consecutive raw data values. In this way, random fluctuations of the measurement values can be reduced. For example, a temperature measurement value can be formed from 3 consecutive raw data as the arithmetical mean thereof.

Advantageously, the filtration of raw data also allows outliers, these being obviously erroneous measurement values, to be eliminated, for example, in that raw data deviating from a preceding measurement value by more than a specified threshold value is ignored. Due to the thermal inertia thereof, the temperature of a temperature probe cannot be changed with infinite speed, so that the maximum possible change between two consecutive measurement signals is limited. If implausible sensor signals are detected and removed from the raw data using an appropriate filter, this is preferably done prior to additional steps for the filtration and processing of the raw data.

In FIG. 2, curves 1 and 2 reflect the curves of the temperature measurement values which were measured using temperature probes installed in the exhaust tract of a vehicle. The ordinate on the left indicates the temperature T in ° C. and the abscissa indicates the time t in seconds. FIG. 2 additionally shows the curve of the exhaust gas temperature, which is curve 3. Corrected temperature values were calculated from curve 1, that is, temperature measurement values of the corresponding temperature probe, and the characteristic quantity of the thermal inertia thereof. Curve 4 indicates the deviation of the corrected temperature values from the exhaust gas temperature. The amount of the deviation is apparent from the ordinate on the right, which denotes the temperature deviation in Kelvin.

The course of curve 4 indicates that the corrected temperature values agree considerably better with the actual exhaust gas temperature than the temperature measurement values of the temperature probes. In particular, it is apparent that the corrected temperature values deviate from the real exhaust gas temperature only during a very short time after a sudden temperature change.

This indicates that the method described above can be used to calculate the exhaust gas temperature with high accuracy from the measurement values of a thermally inert temperature probe. In practical terms, this means that a thermally inert temperature probe can be converted into a temperature probe having no thermal inertia when using the method described above. Another application of the method is to calculate corrected temperature values which do not reflect the exhaust gas temperature, but simulate temperature measurement values of another temperature probe having a higher or lower thermal inertia. To do so, the time constant τ is replaced with the difference of the time constants of the two temperature probes in the equation above.

The method according to the invention can be carried out, for example, by an engine controller of a motor vehicle. It is possible, however, to carry out the method using an evaluation circuit that is provided on the temperature probe. A temperature probe suitable for this can be, for example, the temperature probe known from DE 10 2006 034 284 B3 and additionally can carry an evaluation circuit, which carries out the method described during operation. Such a temperature probe comprises a temperature sensor and a protective tube surrounding the same. The temperature sensor is embedded in the protective tube in a filler material. An insulating powder or a potting compound can be used as the filler material. The evaluation circuit can be configured cost-effectively as an ASIC.

Advantageously, the temperature probes configured with an ASIC can be connected to an engine controller by way of a data bus. It is particularly advantageous that the exhaust gas temperature can be measured in different locations of the exhaust tract of a vehicle using a plurality of temperature probes, wherein the individual temperature probes are each connected to a common data bus, so that the engine controller requires only a single port in order to obtain temperature data from a plurality of temperature probes.

By connecting a plurality of such temperature probes into a system, advantageously the reliability of the system can be increased. In particular, a fault of an individual temperature probe can be detected by comparing the temperature measurement values of the individual temperature probes. After the engine has been shut off for longer periods, all temperature probes of the vehicle should have cooled down to the ambient temperature, which is to say, they should supply agreeing temperature measurement values. A fault of an individual temperature probe can therefore be detected in that the temperature measurement values of the individual temperature probes are compared to each other after extended parking of the vehicle.

Frequently, a fault of a temperature probe is due to the fact that the temperature sensor thereof is subject to drift. In a temperature sensor configured as a measuring resistor, for example, an age-related increase in resistance can be observed, thereby distorting the measurement signal. In such a case, a temperature probe exhibiting a noticeable deviation from the temperature measurement values of the remaining temperature probes can be readjusted using the temperature measurement values of the remaining temperature probes. For example, in order to adjust the deviating temperature probe, the arithmetical mean of the measurement values of the remaining temperature probes can be assumed to be an accurate temperature and the temperature probe supplying a deviating temperature can be adjusted to this mean value.

It is important that such a functional check of the temperature probes and a potential readjustment can only be carried out after the vehicle has been parked for more than a specified time period. This specified time period must be sufficiently long to allow all temperature probes to cool down to the ambient temperature of vehicle. The time period if preferably at least 6 hours, with at least 12 hours being particularly preferred.

What is claimed is:

1. A method for determining the exhaust gas temperature of a vehicle engine using a temperature probe comprising a temperature sensor and a protective tube, surrounding the temperature sensor and projecting into an exhaust gas flow, the method comprising:
determining a series of temperature measurement values with the temperature sensor; and
calculating a corrected temperature value T_{cor} from a plurality of chronologically consecutive temperature measurement values, using a thermal inertia characteristic of the temperature probe.

2. The method according to claim 1, wherein the characteristic is a time constant characterizing the speed with which the temperature probe assumes a changed ambient temperature.

3. A method according to claim 1, wherein the corrected temperature value is calculated in that a corrective term, which is proportional to a deviation from a preceding temperature value, is added to a temperature measurement value.

4. The method according to claim 3, wherein the corrective term is proportional to the characteristic.

5. The method according to claim 3, wherein the corrective term is inversely proportional to the time period between the two temperature measurement values, the corrective term being proportional to the difference thereof.

6. A method according to claim 1, wherein the temperature measurement values are determined by filtering raw data supplied by the temperature sensor.

7. A method according to claim 1, wherein the corrected temperature value T_{cor} is calculated from two consecutive temperature measurement values Tₙ and Tₙ₋₁, which were determined for the times tₙ and tₙ₋₁, and the characteristic quantity τ into T_{cor}=Tₙ+ΔT·τ/Δt, with ΔT being the difference between the consecutive temperature measurement values Tₙ and Tₙ₋₁ and Δt being the difference between the consecutive times tₙ and tₙ₋₁.

8. A temperature probe comprising:
a temperature sensor;
a protective tube surrounding the temperature sensor; and
an evaluation circuit for carrying out the method according to claim 1 and supplying a corrected temperature value.

9. The temperature probe according to claim 8, wherein the temperature sensor in the protective tube is surrounded by a filler material.

10. The temperature probe according to claim 8, wherein the evaluation circuit is an ASIC.

11. A system comprising:
a plurality of temperature probes, each probe including a temperature sensor, a protective tube, and an evaluation circuit; and
a common data bus for connecting the temperature probes to an engine controller.

12. The system according to claim 11, wherein the temperature probes are installed in a vehicle exhaust tract.

13. A method utilizing the system according to claim 11 comprising:
parking a vehicle for more than a specified time period; and
evaluating the temperature measurement values of each temperature probes to determine whether they agree within a specified tolerance range.

14. The method according to claim 13, wherein the step of evaluating the temperature measurement values includes identifying a temperature probe, which after parking the vehicle for a time period that exceeds the specified period, exhibits a noticeable deviation from the temperature measurement values of remaining temperature probes; and
adjusting the identified temperature probe temperature measurement value using the temperature measurement values of the remaining temperature probes.
